(19) United States
(12) Patent Application Publication
(10) Pub. No.: US 2005/0200750 A1
(43) Pub. Date: Sep. 15, 2005

(54) Portable camera and wiring harness

(76) Inventor: David J. Ollila, Marquette, MI (US)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 10/796,356

(22) Filed: Mar. 9, 2004

(51) Int. Cl. H04N 5/225

(52) U.S. Cl. 348/375; 348/376

(57) ABSTRACT

A wiring harness for a portable point-of-view camera includes a power cord, a recording cord and a camera cord. These three cords are mutually interconnected and can be respectively joined with a power source, a recording device, and a camera. A microphone is integrated into the camera cord. The wiring harness can be used to transmit video and audio signals from the camera and microphone to the recording device with a substantially reduced number of wiring connections.

### BACKGROUND

Advances in recording technology and a growing interest in video and audio capture for a variety of applications has created a growing market for point-of-view cameras, which can be clipped to a user's helmet or other clothing item or to equipment. The point-of-view camera can then be used to record images that approximately match the user's perspective when engaged in an activity.

Current state-of-the-art technology re-purposes small (approximately 1″×3″) security cameras for use as portable point-of-view cameras. Such a camera is illustrated in FIG. 1 and includes the following major components: a camera including a lens 12, a lens cover 14, a charge-coupled device (CCD) 16, a signal processor 18, a printed circuit board (PCB) 20, and a casing 22; the camera is connected to a cable 24 to which a video terminal 26 and power terminal 28 are coupled.

The current state-of-the-art, point-of-view camera (e.g., “helmet cam”) is coupled with the recording device (e.g., a camcorder) and other recording equipment, as illustrated in FIG. 2, via the following eight detachable connections:
1) Connector pair 31 couples the power supply 40 with a power splitter 42.
2) Connector pair 32 couples a camera 44 with the power splitter 42.
3) Connector pair 33 couples a microphone 46 with the power splitter 42.
4) Connector pair 34 includes a video connector 48 of an audio/video cable 50 coupled with the RCA terminal of a BNC-to-RCA adapter 52.
5) Connector pair 35 includes a connector on the camera's video output cable 54 coupled with the BNC terminal of the BNC-to-RCA adapter 52.
6) Connector pair 36 includes a connector extended from the microphone 46 coupled with an audio connector 56 of the audio/video cable 50.
7) Connector pair 37 couples the audio/video cable 50 with a camcorder 58.
8) Finally, connector pair 38 couples the camcorder 58 with a remote control 60.

The BNC-to-RCA adapter 52 is required because the security cameras that were utilized as point-of-view cameras included BNC output connectors.

### SUMMARY

A wiring harness is herein described that can connect a camera, a power source and a recording device to enable transmission of power and electronic data signals therebetween with far fewer connections than have been employed in previous wiring configurations. The wiring harness includes a power cord having a connector that can be connected with the power supply, a recording cord having a connector that can be connected with a recording device, and a camera cord having a connector that can be connected with a camera. The camera cord is also coupled with the power cord so as to enable the camera to receive power from the power supply and with the recording cord so that the camera can transmit visual data from the camera to the recording device. Further still, a microphone can be integrated into the camera cord so that it can transmit audio signals to the recording device.

The camera can be mounted on a user's helmet, bicycle, weapon or other article of clothing or equipment (or directly to the user), and the user can then engage in an activity (e.g., sport, observation, demonstration, surveillance, combat, or broadcast entertainment/performance) and have the camera record an audio and video stream that closely matches the user's experience and observations. Alternatively, the camera can be mounted to another animate or inanimate host (other than the user) to record from an alternative perspective.

Advantages offered by embodiments of the apparatus and methods of this disclosure (referred to herein as the “new design”) over the current state-of-the-art apparatus, described above, include the following. The new design is better optimized for point-of-view camera applications and other uses. The reduced number of connections in the new design make the apparatus less confusing and cumbersome. The reduced number of connections, particularly between the recording device and the microphone and camera, also improves the integrity of signals transmitted to the recording device. A point-of-view camera utilizing the new design allows easy disconnection of the harness from the camera. Reduction in the number of separate components in the apparatus simplifies the system and reduces overall system weight and bulk. Fewer cables and reduced cable lengths in the new design can reduce the cable management problems that plagued the state-of-the-art apparatus. Multiple cable lengths can readily be provided via complementary use of an extension cord coupled with the camera. Finally, connection (i.e., plug-type) converters are no longer necessary to enable coupling and communication between components joined by the wiring harness.

### BRIEF DESCRIPTION OF THE DRAWINGS

In the accompanying drawings, described below, like reference characters refer to the same or similar parts throughout the different views. The drawings are not necessarily to scale, emphasis instead being placed upon illustrating particular principles of the methods and apparatus characterized in the Detailed Description.

FIG. 1 is a disassembled view of an existing camera.

FIG. 2 is an image of an existing audio-video recording apparatus.

FIG. 3 is an image of an audio-video recording apparatus of this disclosure.

FIG. 4 is an illustration of one embodiment of a wiring harness of this disclosure.

FIG. 5 is an illustration of another embodiment of a wiring harness of this disclosure.

FIG. 6 is an illustration of an extension cord for the wiring harnesses of FIGS. 4 and 5.

FIG. 7 is an image of a point-of-view camera mounted to a helmet.

### DETAILED DESCRIPTION

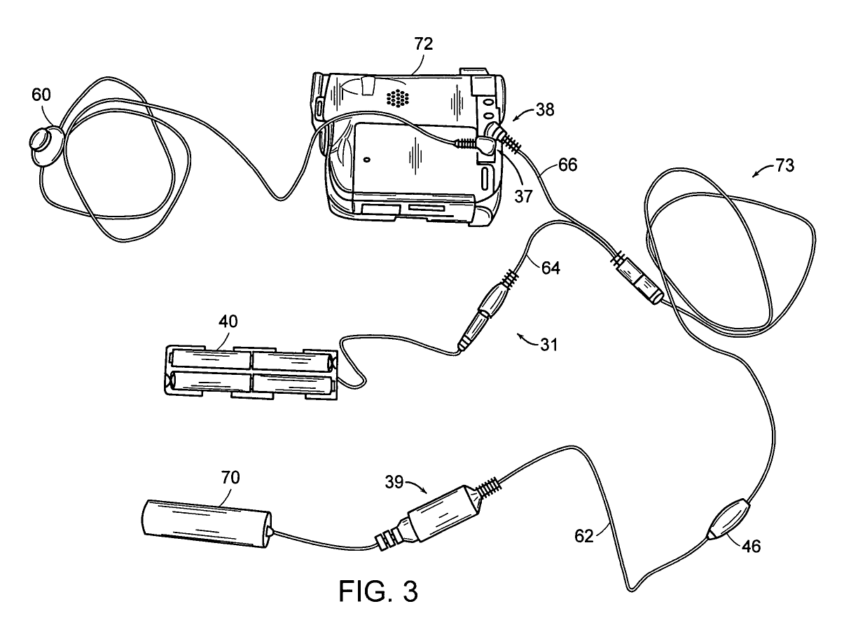

A wiring harness 73 including a camera cord 62, a power cord 64, and an audio-video recording cord 66 is coupled with a power supply 40, a recording device 72 and a point-of-view camera 70 in the embodiment illustrated in FIG. 3. A microphone 46 can be incorporated into the camera cord 62 so as to be able to capture sound and transmit corresponding audio signals from the microphone 46 through conductive wiring in the camera cord 62 to the recording device 72. An embodiment of the wiring harness 73 and related equipment is available from Viosport.com, Inc. of Marquette, Mich., USA, with components manufactured by Sun Disk of Taiwan.

When designed for personal use (i.e., when the camera and other components are afixed to the user), each of the cords 62, 64 and 66 has a length of not more than about 1.5 m. The wiring harness 73 operably joins system components via just three connections, one on each of the three cords 62, 64 and 66. At connection 39, a 4-pin mini-din female connector from the camera is connected with a 4-pin mini-din female connector on a terminal of the camera cord 62. At connection 31, a male 2.1 mm connector from the power supply 40 (in this case, a 12-V power source in the form of a battery pack holding eight AA batteries) is connected with a female 2.1 mm connector on a terminal of the power cord 64. At connection 38, a 3.5 mm male composite plug on a terminal of the recording cord 66 is connected with a 3.5 mm female input on a recording device 72; in this case, the recording cord 66 is connected to an analog input of a hand-held video camera/recorder. The camera cord 62 is connected with both the power cord 64 and the recording cord 66, each at an opposite end from its connector.

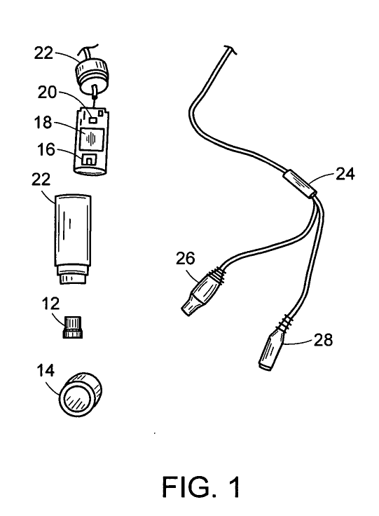

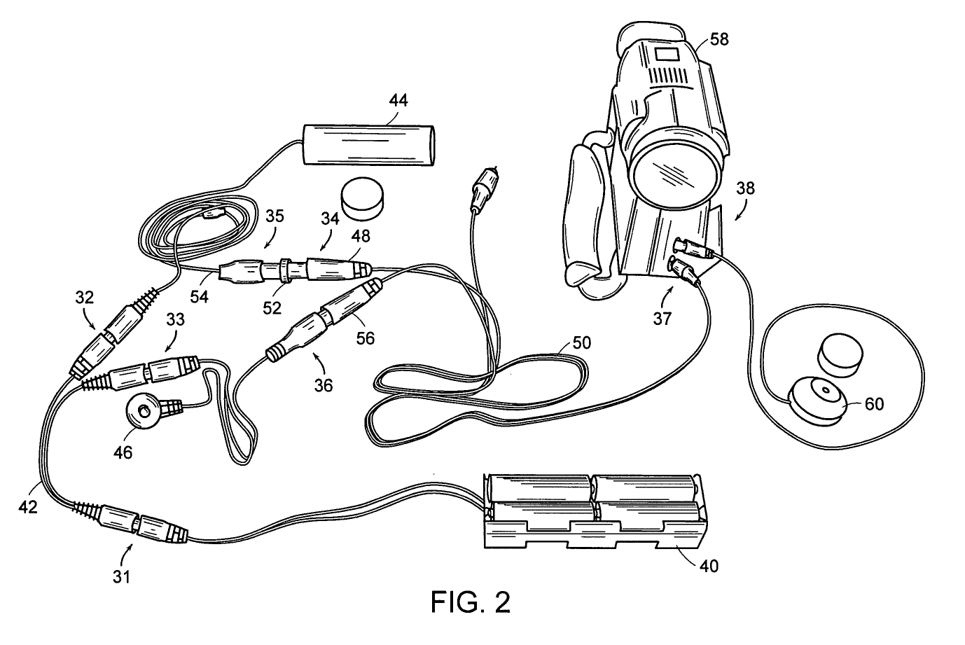

The camera 70 is similar to the camera described in the background, except for the wiring and connectors. The camera 70 captures images and transmits electronic representations to the camera cord 62 of the wiring harness 73 through the camera's connector. In this embodiment, the camera 77 is a tubular-style camera that includes a ¼-inch color charge-coupled device (CCD) sensor from Panasonic. The CCD sensor converts the light pattern that is captured by the camera into electrical signals. The signal processor 18 and printed circuit board 20 (see FIG. 1) convert the signal from the CCD sensor 16 into a signal compatible with the recording device 72 via software written to produce the desired signal format. One embodiment of the camera is sold as the ADVENTURE CAM II by Viosport.com, Inc. (Marquette, Mich., USA), and its technical specifications are as follows:

| | |
|---|---|
| Pick-Up Element: | ¼″ Panasonic Color CCD sensor |
| Number of Pixels: | 512 (H) × 492 (V)/512 (H) × 582 (V) |
| Resolution: | 380 TV lines |
| Min. Illumination: | 2 Lux/F2.0 |
| S/N Ratio: | More than 48 dB (AGC off) |
| Electronic Shutter: | 1/60 (1/50) to 1/100,000 sec |
| White Balance: | Auto white balance |
| Auto Light Control: | 3 windows detec |
| Load impedance: | 75 ohms |
| Standard Board Lens: | f3.6 mm/F2.0 |
| Lens Angle: | 70 degrees |
| Power Source: | DC12 V +/−10% |
| Dimension (mm): | 26 (diameter) × 87 (length) |
| Current Consumption: 80 mA | |
| Weight: | 305 g |
| Cord Length: | 2 inches (5 cm) |
| Cord Terminal: | water-tight mini-din 4-pin connection |

The short cord length allows the user to disconnect the camera and wiring harness while keeping the camera attached to the helmet or other mounting area and also allows for multiple options in wiring configurations based on the terminals of the recording device. Further still, the short length of the cord from the camera easily enables coupling to cable extensions for longer runs.

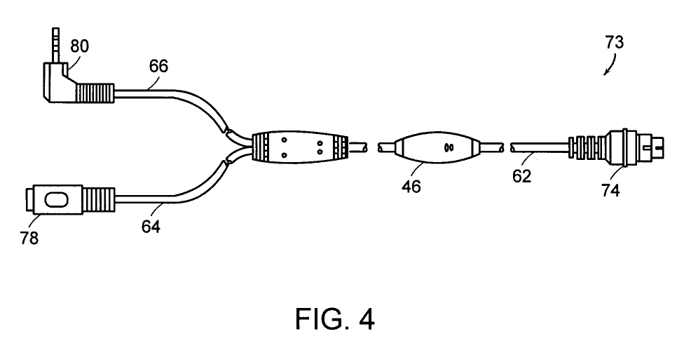

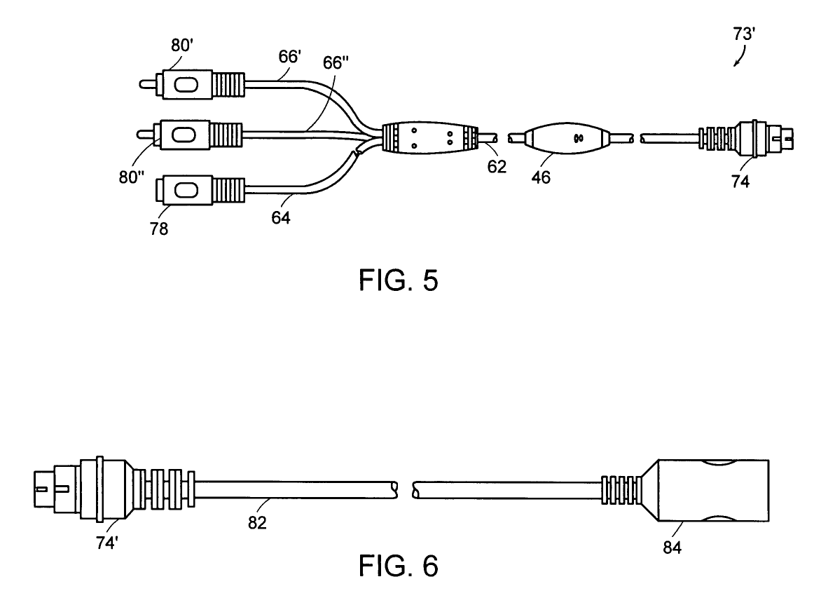

Examples of wiring harnesses 73 and 73′ including the camera cord 62, the power cord 64 and the recording cord 66 are illustrated in FIGS. 4 and 5. In each embodiment, a microphone 46 is incorporated into the camera cord 62 so as to be able to transmit audio signals generated in the microphone 46 through the camera cord 62. One embodiment of the microphone (manufactured by Sun Disk of Taiwan) has the following technical specifications:

| | | |
|---|---|---|
| Audio Output: | 12 | V p—p |
| Power Supply: | 12 | V DC |
| Power Consumption: | 4 | mA |
| Sensitivity: | 58 | dB |
| Resistance: | 2.2 | kΩ |
| Weight: | 5 | g |
| Width: | 6.3 | mm |
| Height: | 29.1 | mm |

As shown, the power cord 64 connects with the power supply 40 via the power connector 78, which is a female 2.1 mm connector. The recording cord 66 is coupled with the recording device 72 via the recording connector 80, which in FIG. 4 is a 3.5 mm male composite plug (similar to a classic headphone jack). The wiring harness 73′ of FIG. 5 is otherwise similar to that of FIG. 4, except the wiring harness 73′ of FIG. 5 includes a pair of recording cables 66′ and 66″, one cable 66′ having a male RCA video connector 80′, the other cable 66″ having a male RCA audio connector 80″. When the camera is to be placed at a more-remote location (e.g., mounted to the top tube, fork, or chain stay of a user's bicycle or to the hull of a user's kayak), an extension cord 82, illustrated in FIG. 6, can be connected with the camera cord 62. The extension cord 82 includes a female 4-pin mini-din connector 84 at one end for connecting with the connector 74 on the camera cord 62 and a male 4-pin mini-din connector 74′ at its opposite end for connecting with the female mini-din connector on the camera 70.

The types of connectors utilized in these embodiments, however, are provided only by way of example as other types of connectors can be substituted to accommodate changes in the reciprocal connectors on the camera, recording device and/or power supply.

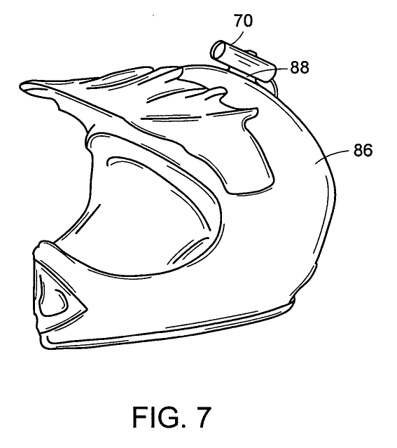

The camera 70 can be attached to a user's helmet 86 via a camera mount 88 secured to the helmet 86, as shown in FIG. 7. When mounted to the user's helmet 86, the camera 70 offers a point-of-view reference that closely matches that of the user (i.e., the camera captures almost exactly what the user sees). Alternatively, the camera 70 can be attached to any other piece of equipment or article of clothing worn or operated by the user. Moreover, the camera can also simply be attached to the user's body, via a headband, for example.

The recording device 72 can be a portable video camera/recorder (camcorder), which is capable of recording live motion video and audio for later replay through videocassette recorders (VCR's), televisions or computers. Alternatively, the recording device 72 can be another type of compact, portable electronic device with a digital or analog storage medium, such as an MP3 player, a personal video player, or a portable hard drive. The power supply 40 can utilize standard batteries (e.g., AA batteries) in a holder with electrical contacts for the batteries, or the power supply can be a rechargeable battery with a male 2.1 mm output connector. A suitable 12-volt rechargeable Li-Ion battery pack is available from Viosport.com, Inc.

With the camera 70 attached, e.g., to the user's helmet, the power supply 40 and recording device 72 can be placed in the user's pockets or in a pack (e.g., a backpack or hydration pack) worn by the user. A remote control 60 includes at least one button or other input means for controlling the recording device (e.g., sending signals to record or stop). The remote control 60 plugs into a designated input on the recording 72 and the controller unit can be held in the user's hand or secured to the user's apparel or equipment for easy manual access by the user. A one-button remote control that works with any LANC-equipped camcorder is available from Viosport, Inc. LANC is a Sony remote control protocol found on select Canon, Sony and other camcorder models. The remote control includes a color LED indicator light; and its functions include power on/off, record, stop, and pause.

The user presses a button on the remote control 60 to commence recording of video and audio from the camera and microphone. Alternatively, the remote control 60 can be omitted from the apparatus, and the user can activate a “record” button on the recording device 72 (e.g., a camcorder set to “VCR” mode) to commence recording. The recording device 72 can then accept signals from the camera 70 and microphone 46. The camera 70 and microphone 46 draw power from the power source 40 to enable them to capture and transmit video and audio, respectively.

The camera 70, wiring harness 73, and other components can be utilized by a user in a wide variety of athletic activities to record, for example, a particular adventure, performance, demonstration or competition. Other applications include use, for example, by military personnel engaged in reconnaissance or combat; for environmental purposes (e.g., observation or tracking of species) by a researcher; in vehicles or aircraft, where the camera is secured to the vehicle or aircraft; in forestry applications, where a forest ranger, for example, can readily record observations of the forest flora and fauna; for training purposes, where recordings can be made of instructional demonstrations or trainee performance; in covert or investigative operations, where the camera and microphone can be used to gather information; in security operations, where the camera and microphone can be used to monitor the premises; in search and rescue operations, where video and audio can be captured for evaluation and future training; in fire fighting, where recorded video and audio can be reviewed, e.g., for performance evaluation and as an evidentiary record for investigating the nature and cause of fires; and by police to capture video and audio that can be used as evidence.

While this invention has been shown and described with references to particular embodiments thereof, those skilled in the art will understand that various changes in form and details may be made therein without departing from the scope of the invention, which is limited only by the following claims.

1. An audio-video recording apparatus comprising:
a power-supply apparatus;
a camera;
a microphone;
a recording device capable of capturing video images from the camera and audio streams from the microphone; and
a wiring harness including the following interconnected cords:
a power cord coupled with the recording device; and
a recording cord coupled with the recording device; and
a camera cord, wherein the camera cord is coupled with the following:
the microphone such that the camera cord can transmit audio from the microphone;
the camera such that the camera cord can transmit images from the camera;
the recording cord such that the camera cord can transmit images from the camera and audio from the microphone to the recording device; and
the power cord such that the camera cord can transmit power from the power-supply apparatus to the microphone and camera.

2. The audio-video recording apparatus of claim 1, wherein the camera includes a mini-din connector through which power from the power-supply apparatus is delivered and through which video images are transmitted from the camera, and wherein the camera cord includes a reciprocal mini-din connector, the mini-din connectors providing the coupling between the camera and the camera cord.

3. The audio-video recording apparatus of claim 1, wherein the power cord includes a power connector through which the power cord is coupled with the power supply apparatus, and wherein the power supply apparatus comprises one or more portable batteries as a power source.

4. The audio-video recording apparatus of claim 1, wherein the power-supply apparatus, the camera, the microphone and the recording device are all operationally coupled through the wiring harness by no more than three disengageable connections, one joining the recording device with the recording cord, a second joining the power-supply apparatus with the power cord, and a third joining the camera with the camera cord.

5. The audio-video recording apparatus of claim 1, further comprising a remote control apparatus including a controller and a cord joining the controller with a recording device such that instructions can be received by the controller and communicated to the recording device to control recording of the video images from the camera and the audio stream from the microphone.

6. The audio-video recording apparatus of claim 1, wherein the power cord, camera, cord and recording cord all have lengths of not more than about 1.5 meters.

7. The audio-video recording apparatus of claim 1, wherein the power supply apparatus is a battery holder having one or more compartments into which one or more batteries can be inserted and in which electrical contacts positioned to contact an anode and cathode of the battery.

8. The audio-video recording apparatus of claim 1, wherein the microphone is integrated into the camera cord.

9. The audio-video recording apparatus of claim 1, wherein the recording cord includes a plurality of cables that are coupled with a plurality of inputs on the recording device.

10. A wiring harness for coupling a camera with a power supply and a recording device, the wiring harness comprising:
a power cord having a connector through which the power cord can be coupled with a power supply;
a recording cord having a connector through which the recording cord can be coupled with a recording device;
a camera cord having a connector through which the camera cord can be coupled with a camera, wherein the camera cord is coupled with the power cord so as to enable the camera to receive power from the power supply and with the recording cord so as to enable data to be transmitted from the camera to the recording device; and
a microphone integrated into the camera cord.

11. The wiring harness of claim 10, wherein the power cord, camera cord and recording cord all have lengths of not more than about 1.5 meters.

12. The wiring harness of claim 10, wherein the connector in the camera cord is a mini-din connector.

13. The wiring harness of claim 10, wherein the connectors in the power cord, recording cord, and camera cord are the only connectors in the wiring harness.

14. A method for capturing and recording video and audio streams using a portable apparatus, the method comprising:
mounting a power supply, a camera, and a recording device including a data storage medium to a user or to equipment operated by the user, wherein the power supply, camera and recording device are electrically coupled via a wiring harness comprising:
a power cord coupled with the power supply
a recording cord coupled with the recording device; and
a camera cord coupled with the camera, with the power cord and with the recording cord, wherein a microphone is integrated into the camera cord; powering the camera and microphone with the power supply to generate video images and
an audio stream that are transmitted to the recording device; and
recording the video images and audio stream on the data storage medium in the recording device.

15. The method of claim 14, wherein the camera is mounted to the user, to an article of apparel worn by the user, or to a piece of equipment worn by the user.

16. The method of claim 15, wherein the camera is mounted to a helmet.

17. The method claim 14, wherein the camera is mounted to a vehicle operated by the user.

18. The method claim 14, wherein the recording devices is mounted to the user, to an article of apparel worn by the user, or to a piece of equipment worn by the user.

19. The method of claim 14, wherein the power supply is mounted to the user, to an article of apparel worn by the user, or to a piece of equipment worn by the user.

20. The method of claim 14, wherein the camera is coupled with the camera via reciprocal min-din connectors extending from the camera and from the camera cord.

21. The method of claim 14, wherein the power supply, the camera, the microphone and the recording device are all operationally coupled through the wiring harness by no more than three disengageable connections, one joining the recording device with the recording cord, a second joining the power supply with the power cord, and a third joining the camera with the camera cord.

22. The method of claim 14, wherein the user operates a remote control apparatus coupled with the recording device to control recording of the video images and audio stream by the recording device.

23. A video apparatus comprising:
a camera for capturing an image and for providing a video signal; and
a wiring harness having:
at least one cable for interconnection with the camera or a preselected device, the at least one cable capable of transmitting the video signal, an audio signal, or power.

24. The apparatus of claim 23, wherein the at least one cable further comprises:
a camera cable for interconnection with the camera, the camera cable capable of transmitting the video signal, the audio signal, or the power;
a recording cable for interconnection with a recording device, the recording cable capable of transmitting the video signal, the audio signal, or the power; or
a power cable for interconnection with a power supply, the power cable capable of transmitting the power.

25. The apparatus of claim 24, further comprising a connector for interconnecting at least two of the camera cable, the recording cable, and the power cable.

26. The apparatus of claim 24, further comprising a first connection for joining the camera with the camera cable.

27. The apparatus of claim 24, wherein the preselected device further comprises:
a recording device coupled with the recording cable, the recording device capable of receiving from the recording cable the audio signal or the video signal; or
a power supply coupled with the power cable, the power supply capable of providing the power to the power cable.

28. The apparatus of claim 27, further comprising a second connection for joining the recording device with the recording cable.

29. The apparatus of claim 27, further comprising a third connection for joining the power supply with the power cable.

30. The apparatus of claim 24, further comprising a microphone in communication with the camera cable, the microphone capable of capturing sound and providing the audio signal to the camera cable.

31. The apparatus of claim 24, further comprising a remote control in communication with the recording device, the remote control for generating a signal for receipt by the recording device to control recording of the audio signal or the video signal.

32. The apparatus of claim 23, further comprising an extension cable interconnected with the at least one cable.

33. The apparatus of claim 23, further comprising a camera mount for mounting the camera to a predetermined object or a user.

34. The apparatus of claim 24, wherein the recording cable further comprises a first recording cable having a video connector for interconnection with the recording device and a second recording cable having an audio connector for interconnection with the recording device.

35. The apparatus of claim 24, further comprising a camera connector in communication with the camera and a camera cable connector in communication with the camera cable, the camera connector and the camera cable connector for receiving and transmitting the video signal, the audio signal, or the power.

36. The apparatus of claim 27, wherein the power supply further comprises a battery holder having a compartment for holding a battery or a battery for disposal therein.

37. An audio-video apparatus comprising:
a camera for capturing an image and providing a video signal;
a recording device for recording the video signal or an audio signal;
a power supply for providing power; and
a wiring harness having:
a camera cable for interconnection with the camera, the camera cable having a microphone in communication therewith, the microphone for capturing sound and providing the audio signal, the camera cable capable of receiving and transmitting the video signal or the audio signal;
a recording cable for interconnection with the recording device, the recording cable capable of receiving and transmitting the video signal or the audio signal;
a power cable for interconnection with the power supply, the power cable capable of receiving and transmitting power; and
a connector for operably interconnecting the camera cable, the recording cable or the power cable with a preselected device or a cable.

38. The apparatus of claim 37, wherein the connector further comprises:
a first connection for joining the camera with the camera cable;
a second connection for joining the recording device with the recording cable; or
a third connection for joining the power supply with the power cable.

39. The apparatus of claim 37, further comprising:
a camera mount for mounting the camera to a predetermined object or a user;
an extension cable for interconnection with the wiring harness; or
a remote control for communicating a signal to the recording device to control recording of the video signal or the audio signal.

40. The apparatus of claim 37, wherein the camera cable, the recording cable, or the power cable is approximately 1.5 meters or shorter.

41. A wiring harness for use with a communication apparatus, the wiring harness comprising:
at least one cable for interconnection with a camera or a preselected device, the cable capable of transmitting at least one of a video signal, an audio signal, or power.

42. The wiring harness of claim 41, wherein the cable further comprises:
a camera cable for interconnection with the camera, the camera cable capable of transmitting the video signal, the audio signal, or the power;
a recording cable for interconnection with a recording device, the recording cable capable transmitting the video signal, the audio signal, or the power; and
a power cable for interconnection with a power supply, the power cable capable of transmitting the power from the supply.

43. The wiring harness of claim 41, further comprising a microphone in communication with the at least one cable, the microphone capable of capturing sound and providing the audio signal to the camera cable.

44. The wiring harness of claim 42, wherein the recording cable, the power cable, or the camera cable is approximately 1.5 meters or shorter.

45. The wiring harness of claim 42, further comprising a mini-din connector for interconnecting the camera cable and the camera.

46. The wiring harness of claim 41, further comprising no more than three connectors for forming at least one interconnection associated with the at least one cable.

47. A method for capturing and recording communication signals using a portable apparatus, the method comprising steps of:
mounting a camera to a predetermined object or user;
receiving, by a wiring harness having at least one cable for interconnection with the camera or a preselected device, a signal; and
providing the signal to the camera or the preselected device.

48. The method of claim 47, wherein the preselected device further comprises a recording device, a power supply, or a microphone.

49. The method of claim 47, further comprising:
providing power from the power supply to the camera or the recording device via the wiring harness;
providing the audio signal via the microphone or the video signal via the camera; and
receiving and transmitting the audio signal or the video signal via the wiring harness; or
receiving and recording the audio signal or the video signal via the recording device.

50. The method of claim 47, wherein the wiring harness further comprises no more than three selectively disengageable connections for interconnection with the camera or the preselected device.
